(19) United States
(12) Patent Application Publication
(10) Pub. No.: US 2004/0044991 A1
(43) Pub. Date: Mar. 4, 2004

(54) Preprocessor for a predetermined document type definition, system for processing markup language documents, and method and computer program product for this purpose

(76) Inventors: Maren Eschermann, Untersiggenthal (CH); Martin Naedele, Zurich (CH); Otto Preis, Zeihen (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/073,954

(22) Filed: Feb. 14, 2002

(30) Foreign Application Priority Data
Feb. 16, 2001 (EP) 01810161.8

(51) Int. Cl. G06F 9/44

(52) U.S. Cl. 717/120; 717/143

(57) ABSTRACT

The invention relates to a preprocessor (2) for a predetermined document type definition (DTD), comprising at least one predetermined interface for interchanging information with interfaces of application units (1, 6); and comprising a conversion means for converting application information from an application unit (1, 6) into calls to a markup language processor (3), with the calls satisfying the DTD, and for converting markup language information from the markup language processor (3) into return information for transmission to an application unit (1, 6), with the return information being interpretable by the application unit (1, 6). The invention is likewise based on an overall system having the preprocessor (2), and on a method for processing a markup language file (5).

### FIELD OF THE INVENTION

The invention relates to a preprocessor for a predetermined document type definition (DTD) having interfaces to application units and having a markup language processor, to a system which includes this preprocessor for processing markup language documents, to a method for producing valid markup language documents which are conforming with a specific DTD, and to a computer program product for implementation of this method.

### BACKGROUND OF THE INVENTION

The use of markup languages for recording and structuring information is becoming increasingly important. The generation as well as the processes for reading and use of the information stored in markup language documents may, however, quickly indicate the limits of generic processors with regard to their processing, as well as limits relating to the standardized language scope of specific markup languages, and may lead to the necessity for supplementary data processing programs in order to make it possible to store and call information which can be utilized. These problems will be explained in the following text using an example from the field of power generation and distribution, although comparable problems may also occur in other fields, and the present invention is also aimed at providing a solution in these fields.

IEC Standard 61850 may be regarded as the future Standard for data interchange in station control technology. Its aim is to allow manufacturer-independent application interoperability between the various components and apparatuses in a station control system (Substation Automation System, SAS). Part 6 of this Standard specifies the Substation Configuration Language (SCL), in order to allow interoperable interchange of communications system configuration data between apparatuses and system configuration tools from different manufacturers. SCL can be used to describe widely differing aspects of a station control system, such as:

the configurations of existing intelligent electronic apparatuses,

the configurations of the communications system,

the topology of the switchgear assembly, and

its relationships with the functionality implemented in the internal electrical apparatuses.

In order to ensure compatibility with the important information technology standards, SCL is based on the page description language XML (extensible markup language), Version 1.0. Part 6 of IEC 61850 includes a Document Type Definition (DTD), which defines the specific XML syntax for SCL documents and their semantics.

The configuration states (which can be described using the SCL) of a station control system are in any case stored in the form of SCL-conforming XML documents.

XML is a Standard for representing information in document form. XML is one of the so-called markup languages which are used for structuring documents or general information. A distinction is in this case drawn between so-called meta languages, which allow the definition of different markup languages and, for their use, require specification in the form of command and identifier definitions for the elements, and actual markup languages which relate more specifically to the structuring since they have a predetermined identifier and command scope. Markup languages include, for example, GML, SGML, HTML and XHTML as well as XML itself. XML documents are documents which structure data, but do not format it. The individual entries in an XML document are, in fact, associated with specific meaning contents. XML allows information to be structured on the basis of the sense of its content and hence, for example, goes beyond the HTML Standard, which was developed in parallel with it and which, for a predetermined scope of commands, defines only simple information structuring and, essentially, information relating to the presentation of the document (for example characters and their size). The individual entries or elements in an XML document generally comprise a command, which is also referred to as a “tag” and which, for example, can represent the meaning of a specific information item, as well as data, for example text chains, to which the command in the entry can be applied. A so-called well-formed XML document includes at least one so-called prolog in which, for example, the XML version is stated, and a further element. In this case, the XML specification defines only how XML documents are to be produced, but not the type of information which can be stored in an XML document. The definition of such permissible tags is in fact based on document type definitions (DTD), which indicate definitions of the permissible entries in an XML document which is conforming with a respective DTD. For the purposes of the present invention, the expression document type definition shall be understood as meaning any expanding definition of the structure of markup language documents, irrespective of whether such expansions are or are not provided in the definition of the markup language (that is to say going beyond the “permitted” scope of the language definition).

Such a DTD actually represents the definition of SCL documents. If an XML document is not only well-formed but also complies with the rules of an existing DTD as well, then this is referred to as a valid document. The DTD may either be referred to in the prolog, or may be included in the document.

Various programming interfaces have been developed in order to make it possible to produce, read and modify XML documents (or documents in other markup languages). These are so-called application programming interfaces (API). An API defines the rules and conventions which describe how a piece of software can be used by another piece of software. When using such an API for access, the data in XML documents is represented, by way of example, in the form of structures which have branches like a tree (the so-called Parse tree) and have nodes, and which can be interpreted by means of suitable programs. One of these APIs is the Document Object Model (DOM). The use of DOM-API thus requires navigation through XML documents in terms of generic nodes, in which case a node may correspond to an element, an attribute, a comment etc. The actual XML data, that is to say the values of the attributes and elements, is transferred in both directions in the form of character strings.

In addition to DOM, there are other interface specifications, for example the DOM Level 2, Simple API for XML (SAX), or Java API for XML parsing (JAXP) expansions.

DOM and other APIs for access to documents in the format of a markup language are merely specifications, and need to be converted into specific programs. This is done by means of processors which are able to record the content of, for example, XML documents and to present it to API-calling programs such that it complies with the DOM specification or some other API. Other programs may thus submit queries to the XML processor via an API-conforming interface by sending information to this XML processor via the interface, containing commands and/or contents such as text or the like, using the API format. The marker language processor responds to the transmission of information containing queries relating to the structure of an XML document by transmitting return information which provides the requesting program with information on the structuring of the processed markup language document.

Currently existing API-conforming markup language processors, for example an XML processor that is available from Microsoft, are, in fact, generic in the sense that they do not offer support for a specific DTD. This means, for example, that attribute values are not checked against the attribute type, so that, for example, any NMTOKEN can appear in an element which is characterized as ENUM. There is no check to determine whether this value is included in the list of permitted values.

Furthermore, content restriction rules (containment constraint rules) which define the multiple or conditional content of an element are not checked and no specific, semantic checks are carried out, for example to determine whether the “voltage” attribute actually contains a number together with a voltage unit. Using a generic API-conforming markup language processor, it is therefore possible to produce documents (with a specific DTD), for example SCL documents, which are well-formed XML files. However, there is no guarantee that such a document is also a valid XML file, for example a valid SCL file. Even if the file is valid, there is no guarantee of semantic correctness. Only when a specific markup language document is loaded does a generic markup language processor check it against the DTD that is being used, for example the SCLDTD, although no specific error information is produced. The semantic correctness cannot be checked on the basis of the DTD, since the DTD defines only the syntax, but not the semantics of markup language documents.

For the configuration of a station control system, this would mean that SCL files produced by means of a configuration tool having a generic XML processor could possibly be invalid or semantically incorrect. If a file produced in such a way is passed to an intelligent electronic appliance that is to be configured, the following situation could occur:

If the SCL file is invalid, the process of loading it into the appliance could fail.

If the SCL file is semantically incorrect, the process of configuring the intelligent electronic appliance would fail, or the intelligent electronic appliance could be configured incorrectly.

In order to avoid this disadvantageous situation in the prior art, each configuration tool, and the software of each configurable appliance that can read or write SCL files, is equipped with its own specific SCL module, which checks the SCL syntax and semantics when producing or reading SCL files.

This is associated with increased programming complexity and, owing to the different implementations, can also possibly lead to incompatibilities, for example when files are processed by a number of appliances.

The object of the present invention is thus to provide an improved system, which ensures the correctness of markup language documents which are intended to comply with a specific DTD.

### SUMMARY OF THE INVENTION

This object is achieved by providing a preprocessor for a predetermined document type definition as claimed in the independent patent claim 1, by a system for processing markup language documents as claimed in the independent patent claim 14, by a method for producing markup language documents as claimed in the independent patent claim 21, and by a computer program product as claimed in the independent patent claim 27. Further advantageous embodiments, aspects and details of the present invention can be found in the dependent patent claims, in the description and in the attached drawing.

The object is based on the principle of providing a specific preprocessor which, firstly, is able to interchange data with a generic markup language processor and, via this processor, to produce and read correct DTD-conforming markup language documents and, secondly, can provide an interface to any desired application apparatuses. It is self-evident that the present invention is not restricted to the processing of SCL documents even if, in the introductory part, the existing problems have been described with reference to SCL documents for station control technology. In fact, the present invention can in principle be used for processing markup language documents in which the question relates to the correctness and conformity with a specific DTD.

Due to the increasingly widespread use of markup languages such as XML, SGML or HTML, the invention has a wide field of application.

The invention is thus based on a preprocessor for a predetermined document type definition (DTD), having at least one predetermined interface for interchanging information with interfaces of application units; and a conversion means for converting application information from an application unit to calls to a markup language processor, with the calls at the same time satisfying the DTD, and for converting markup language information from the markup language processor to return information for transmission to an application unit, in which case the converted return information can be interpreted by the application unit.

In the present invention, as in the field of data processing in general, the term preprocessor means a program object which converts incoming data on the basis of specific criteria, and outputs the converted data.

The preprocessor has a predetermined interface for connection to application units. This advantageously means that, once this interface has been defined, the preprocessor can be accessed from widely differing application units. This avoids the problem, which is known in the prior art, of reprogramming corresponding software modules in each individual application unit. When programming the application units, only a (simpler) functionality need then be implemented in order to call the predetermined interface of the preprocessor.

The preprocessor according to the invention can be implemented in a functional unit with the generic markup language processor. This means that the two functionalities are combined in a single software object, so that the communication between the two parts can be initiated internally, without specific, defined interfaces needing to be introduced.

Alternatively, the preprocessor can be inserted between different application units which can use it and a conventionally generic markup language processor, and can be coupled to both via interfaces. In this way, it is possible to use an existing generic markup language processor, so that the programming complexity to implement the invention is reduced considerably.

The preprocessor includes a conversion means, which in each case matches the various structures of the information interchanged between the application apparatuses and the markup language processor to the needs of the opposite end and, furthermore, processes the calls supplied to the markup language processor such that they correspond to the respectively used DTP. The expression application unit should in this case be regarded in the widest sense and, in addition to configuration tools such as programs for a control computer or specific mobile configuration appliances, also includes configurable, intelligent electronic apparatuses for station control technology, the communications system used for station control technology, and all the other elements.

For applications other than those relating to station control technology, an application unit should be regarded as any unit, irrespective of whether this is in the form of hardware (for example in the case of appliances with a built-in ASIC for processing markup language files) or software, operating with markup language documents which have to comply with a specific DTD.

The markup language processor is a processor which is able to process files in the format of the markup language, that is to say to produce, to modify and to read them. The files processed by the markup language processor may include widely different information relating to one or more appliances to be configured.

The preprocessor preferably interacts with a markup language processor which is conforming with a predetermined API, with the preprocessor having at least one interface for transmitting calls to the markup language processor and for receiving markup language information from the markup language processor, and the calls are API-conforming calls.

For the purposes of the present invention, API-conforming means that the markup language processor has a programming interface which can receive method calls and can output information which corresponds to the definition of a specific API. The data is thus interchanged via the API-conforming interface of the markup language processor, so that the preprocessor must be able to generate corresponding commands.

The markup language that is used is preferably XML, since this is an established Standard, allows information to be structured easily, existing software can easily be adapted, and the language is well understood, since it is well known.

The API which is used may be any suitable API which can reflect the markup language that is used and which allows necessary manipulations to the documents, such as SAX or DOM when using XML.

The preprocessor according to the invention may preferably be an SCL preprocessor, that is to say one that is suitable for processing information in such a way that it checks with the SCL-DTD before passing it on to a requesting application unit, thus making it possible to avoid configuration errors. The use of a preprocessor specifically for generating and reading SCL documents unexpectedly solves various problems which have been found in the prior art, as described above, and hence simplifies the design and implementation of administration systems for station control technology.

Information which is passed via the interfaces is transmitted between the application units, the preprocessor according to the invention and the markup language processor. In this case, it is possible to distinguish between different information items. The information sent from an application unit to the preprocessor is referred to, according to the invention, as application information. This information should be transmitted in a standardized format, which corresponds to the software interface of the preprocessor. The application information generally includes instructions for manipulations to the markup language file. If the application unit is a configuration tool, the input parameters of the configuration tool may be quoted as application information and may be sent to the preprocessor together with the appropriate instructions for manipulation of the markup language file. If the application unit is an intelligent electronic appliance, typical application information may be, for example, a check relating to the contents of the markup language file. In one situation, in addition to pure instructions, structure information, that is to say information relating to the actual content of a markup language file to be produced and relating to the syntactic relationship between such information items is thus likewise transmitted, while, in the other case, only an instruction is transmitted.

The application information may preferably include appliance configuration parameters for producing a markup language document for the configuration of at least one configurable appliance.

The application information is converted in the conversion means to method calls which can be transmitted to the markup language processor. During this conversion process, the application information is at the same time changed to a form which is conforming with the DTD being used, in order to obtain a markup language file which is not only well formed, but is likewise valid.

Markup language information which is sent from the markup language processor, such as information relating to the structuring of the processed markup language document, uses an API-conforming format in the opposite direction. The markup language processor thus transmits via the interface information, for example, relating to the generic nodes, such as elements, attributes, comments, etc.

The conversion means according to the invention converts this information to return information, which can be transmitted to an application unit. It must be noted that this application unit need not be identical to the previously mentioned application apparatus which is transmitting information. Thus, in practice, it is frequently possible, particularly in the field of plant control systems, that a first application unit, for example a configuration program on a data processing system, produces or modifies a configuration file in the markup language format which, for example, is conforming with the SCL; and that a second application unit, for example a configurable appliance in a distribution substation, reads the data in this file, in order to configure itself. According to the invention, it is preferable for the return information to include structure information relating to a DTD-conforming markup language file which is processed by the markup language processor. This structure information may in turn include identifier information, that is to say so-called tags, and/or content information, for example information relating to configurations when using SCL files. The return information may thus include appliance configuration parameters for an existing markup language document for the configuration of at least one configurable appliance.

These appliance configuration parameters (as return information) and/or return information of any general type, are converted by the conversion means to converted return information, which can be interpreted by the application apparatus. This conversion to converted return information includes, firstly, a format conversion of the API-compatible return information to a parameter format which is likewise used by the respective application unit.

Furthermore, the process of conversion to converted return information preferably likewise includes, however, a check relating to the DTD-conformity of the transmitted information, in order to ensure that, in addition to the mere format, syntactic and semantic conditions are satisfied by the return information sent back to the application apparatus.

It is thus preferable for the conversion means to have means for checking the syntax of the received information for conformity with the DTD, and the semantics for compliance with the conditions of the respective application unit to be configured. This check is carried out both with regard to the application information and with regard to the return information transmitted by the markup language processor. This makes it possible to ensure that the syntax of the transmitted information complies with the DTD being used such that, firstly, the application unit can receive information which can be utilized and, secondly, the markup language processor is able to produce valid markup language documents in the respective DTD format.

Even when a valid markup language document with a specific DTD is present, it is possible for the transmitted information to be incorrect, or unacceptable, for various reasons. Thus, for example, even if the type of transmitted information corresponds to the type of identifier responsible for it, the information which is actually transmitted may be outside an absolute maximum possible value range. Errors would then once again occur when using the markup language document. It is thus preferable for the conversion means to have means for checking the logical correctness and/or permissibility of structure information included in the information. To do this, it may be necessary to supply the preprocessor with further information which includes, for example, appliance-specific presets for producing SCL files, since the permissibility may differ from one configurable appliance to another configurable appliance.

The invention is furthermore based on an overall system which includes a preprocessor according to the invention. This is a system for processing valid markup language documents which are conforming with a specific document type definition (DTD) with the system having an application unit for producing and/or reading a set of application information items, a preprocessor according to the invention, and a markup language processor for interchanging information with the preprocessor, in order to process a markup language document which is valid with respect to the DTD.

All that has been said above with regard to the preprocessor according to the invention applies equally to the system, so that reference is made to the entire contents of what has been stated above.

In particular, the preprocessor and markup language processor may be combined to form a functional unit.

It is likewise preferable for the markup language processor to be a generic markup language processor with an API-conforming interface to the preprocessor, as is explained in detail above.

According to the invention, the application unit may in this case be a configuration program or a configurable appliance. The system is thus able not only to produce DTD-conforming markup language documents but also in turn to read them, and to provide the information to an appliance which is to be configured, when the latter produces a request.

The application information items may be appliance configuration parameters for configuration of a configurable appliance.

In a corresponding way, the predetermined DTD may, for example, be the Substation Configuration Language (SCL).

Furthermore, the invention is based on a method for producing markup language documents which are conforming with a predetermined document type definition, with the method having the following steps:

production of a set of application information items;

production of an information representation, which is conforming with the predetermined DTD, from the application information; and

production of a markup language document, which is valid with respect to the DTD, from the information representation.

The application information items which are used may preferably be appliance configuration parameters for at least one configurable appliance. A set of appliance configuration parameters is normally produced by means of user used to produce a parameter representation, which is conforming with the DTD being used. For example, as mentioned above, this may be done in a preprocessor according to the invention. The parameter representation may, for example, be a parameter representation which is conforming with a specific API.

In a final step, the parameter representation which is produced is converted to a markup-language-conforming configuration file. This step may be carried out, for example, after transmitting the parameter representation via the API interface in a conventional markup language processor.

It is preferable for the appliance configuration parameters to be checked syntactically and/or semantically before the DTD-conforming parameter representation is produced from them.

It is likewise possible to check that the sense of their content is correct, as described above with reference to the preprocessor.

The invention may be characterized in that the process of producing the valid markup language document has the following steps:

production of calls from the DTD-conforming information representation, which are conforming with a predetermined API;

transmission of the API-conforming calls to a markup language processor via an interface which is conforming with this API;

execution of the API-conforming calls in order to process the valid markup language document.

Furthermore, in the method according to the invention, the application information items may be appliance configuration parameters for at least one configurable appliance. The API-conforming instruction structures can be produced by means of a preprocessor according to the invention.

Furthermore, the opposite processing direction, that is to say the parsing of a markup language document by means of a markup language processor and the conversion of the information obtained in this way to application return information for the application unit, is also intended to be covered by the invention.

Finally, the invention is also based on a computer program product which can be loaded into an internal memory in a digital data processing means and has computer program code means which execute the method as claimed in the invention when they are loaded and run in one or more data processing means. The computer program product thus describes and implements the preprocessor according to the invention. The computer program product is preferably a computer-legible medium with a computer program stored in it in order to carry out the method according to the invention.

### BRIEF DESCRIPTION OF THE DRAWING

FIG. 1 shows, schematically, the arrangement of the various elements in the conversion system according to the invention.

Ways to implement the invention

One important aspect of the invention is to provide a specific reusable preprocessor, for example an SCL processor, as a software product which can be used for any software (application unit) which accesses the respective markup language documents. This preprocessor may be implemented, for example, by means of Microsoft(TM), COM components, the script systems PHP or Perl, or by means of Java(TM) classes.

This preprocessor has the following important features: all the necessary syntactic and semantic checks are carried out as early as possible. This can be achieved by providing specific interfaces which are implemented for each element defined in the DTD, for example the SCL elements in accordance with IEC 61850, with specific methods for setting attributes, adding elements etc., which can carry out all the necessary steps, and which can return an error message in the event of incorrect input parameters, such as incorrect application information or incorrect API-conforming information from the markup language processor.

Furthermore, the preprocessor can be equipped such that it limits the capabilities for user inputs in such a way that only correct information can be entered in the DTD document that is produced. This can be achieved by only specific DTD interfaces being accessible which, for example, do not allow the addition of an attribute which does not exist at all for a given element of the DTD.

Finally, the provision of methods which allow convenient production of DTD-conforming markup language files, for example SCL files, and information to be obtained from such DTD-conforming markup language files, is a feature of one preferred embodiment of the preprocessor according to the invention.

The preprocessor according to the invention can be based on an existing generic markup language processor, for example an XML processor. This in itself results in the provision of a large proportion of the functionality which is required, since the fundamental behavior of an XML processor and of the processor according to the invention are similar in some respects. As already explained, it is likewise possible to expand an existing markup language processor in order to integrate the lack of functionality of a preprocessor in it.

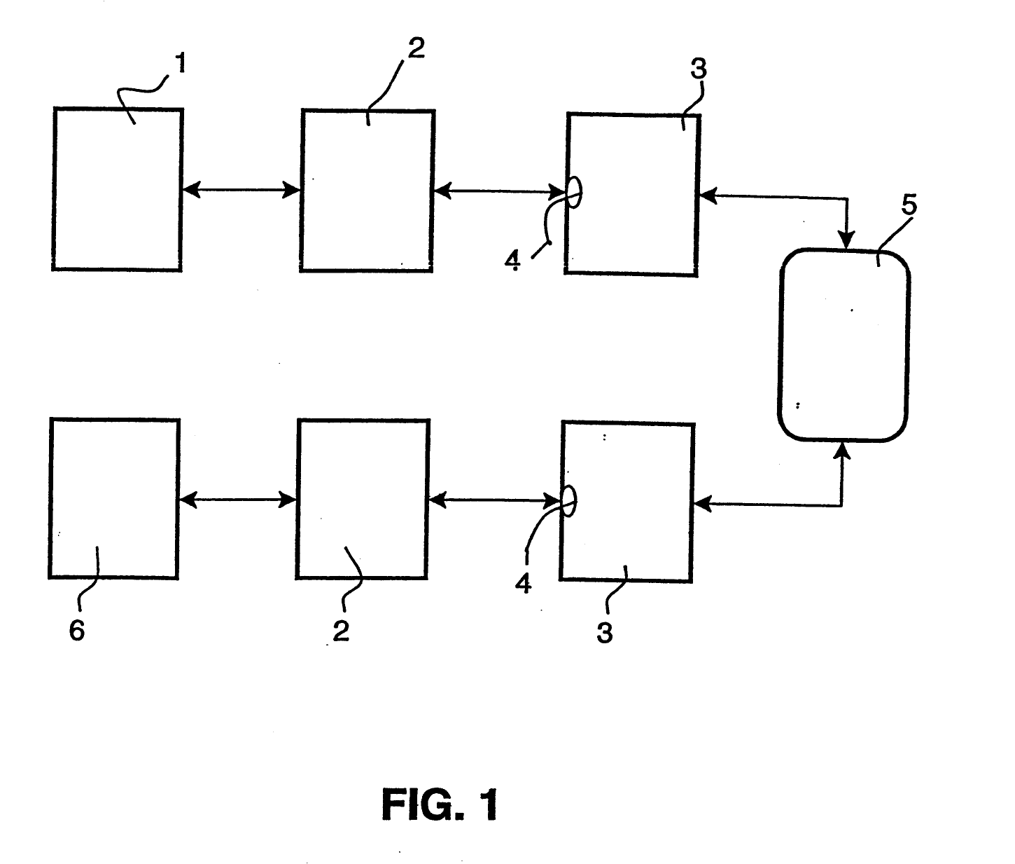

FIG. 1 shows, schematically, one possible design for the system according to the invention, based on the example of the administration of appliance configurations. In the upper line, a DTD document is produced by a configuration tool 1 sending its input parameters via a suitable interface to the preprocessor 2. The latter converts the input parameters that have been received to calls to the, for example, DOM-APIs, which are sent via a further connection to a generic markup language processor 3, which provides an API interface 4 for this purpose. The markup language processor now uses the transmitted DTD-conforming appliance parameters to generate a DTD-conforming markup language file 5. The information which is produced is supplied, possibly via the markup language processor 3, to the preprocessor 2, which transmits it to the configuration tool 1 in order, for example, to produce a display on the screen as feedback that the input was correct.

Access of a configurable appliance is described in the lower line. The configurable appliance, for example an intelligent electronic appliance 6, produces a request via a preprocessor 2, which may be identical to the preprocessor 2 for producing the DTD-conforming markup language file, and converts this request to an API-conforming method call, for example to a DOM-conforming call, and passes it on via the API-conforming interface 4 thereof or of some other generic markup language processor 3, so that, after reading the configuration information included in the DTD-conforming document, it can transmit return information, processed as API-conforming information, to the preprocessor 2, which converts it to corresponding parameters which can then be read by the appliance 6, which can then configure itself autonomously.

The preprocessor 2 and the markup language processor 3 have identical reference symbols in the upper line of FIG. 1 (production) and in the lower line of FIG. 1 (reading) in order to illustrate the fact that this may be the same processor in each case, which can process both types of requests from different application units. Two boxes are in each case shown, in order, on the other hand, to make it clear that different processors may also access one document.

The functional elements comprising the preprocessor 2 and the markup language processor 3 may be combined to form a unit. In this case, there is no need to use a markup language processor with a predetermined API-conforming interface 4, since the elements can communicate internally. The availability of the specific preprocessor according to the invention, for example an SCL processor, with an SCL-specific interface, has various advantages. For example, there is an improvement to the error checking during reading and writing of the markup language files that are produced. The amount of effort required for design and implementation is reduced due to the reusability of the preprocessor. It is thus possible to market new products more quickly. By focusing on a small number of software products, it is possible to improve the quality of the software, which in turn leads to a reduction in the test effort. The preprocessor according to the invention may thus represent an important integral component of future station control technology and can be marketed as a software product both therein and in further application fields.

List of Reference Symbols

1 Configuration tool (application unit)

2 Preprocessor

3 Markup language processor

4 API-conforming interface

5 DTD-conforming markup up language document

6 Configurable appliance

1. (Amended) A preprocessor for a predetermined document type definition (DTD), comprising
at least one predetermined interface for interchanging information with interfaces of application units; and
a conversion means
for converting application information from an application unit into calls to a markup language processor, with the calls satisfying the DTD, and
for converting markup language information from the markup language processor into return information for transmission to an application unit, with the return information being interpretable by the application unit.

2. (Amended) The preprocessor as claimed in claim 1, wherein
the markup language processor is conforming with a predetermined API,
the preprocessor has at least one interface for transmitting calls to the markup language processor and for receiving markup language information from the markup language processor, and
the calls are API-conforming calls.

3. (Amended) The preprocessor as claimed in claim 1, wherein the markup language for the markup language document is XML, and the markup language processor is an XML processor.

4. (Amended) The preprocessor as claimed in claim 3, wherein the API which is used is the Document Object Model (DOM).

5. (Amended) The preprocessor as claimed in claim 1, wherein said preprocessor is a substation configuration language (SCL) conforming preprocessor.

6. (Amended) The preprocessor as claimed in claim 1, wherein the application information and the calls include instructions.

7. (Amended) The preprocessor as claimed in claim 1, wherein the application information and the calls include structure information for building into a markup language file which is processed by the markup language processor and which is valid with respect to the DTD.

8. (Amended) The preprocessor as claimed in claim 1, wherein the return information includes structure information relating to a markup language file which is processed by the markup language processor and which is valid with respect to the DTD.

9. (Amended) The preprocessor as claimed in claim 8, wherein the structure information includes identifier information and/or content information.

10. (Amended) The preprocessor as claimed in claim 1, wherein the application information includes appliance configuration parameters for producing a markup language document for the configuration of at least one configurable appliance.

11. (Amended) The preprocessor as claimed in claim 1, wherein the return information includes appliance configuration parameters for an existing markup language document for the configuration of at least one configurable appliance.

12. (Amended) The preprocessor as claimed in claim 1, wherein the conversion means comprises means for checking the syntax of the received information for conformity with the DTD.

13. (Amended) The preprocessor as claimed in claim 1, wherein the conversion means comprises means for checking the logical correctness and/or permissibility of structure information included in the information.

14. (Amended) A system for processing valid markup language documents which are conforming with a predetermined document type definition (DTD), comprising
an application unit for producing and/or reading in a set of application information items;
a preprocessor as claimed in claim 1; and
a markup language processor for interchanging information with the preprocessor, for processing a markup language document which is valid with respect to the DTD.

15. (Amended) The system as claimed in claim 14, wherein the preprocessor and the markup language processor are combined to form a functional unit.

16. (Amended) The system as claimed in claim 14, wherein the markup language processor is a generic markup language processor having an API-conforming interface to the preprocessor.

17. (Amended) The system as claimed in claim 14, wherein the application unit is a configuration program.

18. (Amended) The system as claimed in claim 14, wherein the application unit is a configurable appliance.

19. (Amended) The system as claimed in claim 14, wherein the application information items are appliance configuration parameters for configuring a configurable appliance.

20. (Amended) The system as claimed in claim 14, wherein the predetermined DTD is the Substation Configuration Language (SCL).

21. (Amended) A method for producing markup language documents which conform with a predetermined document type definition (DTD), comprising the following steps:
production of a set of application information items;
production of an information representation, which is conforming with the predetermined DTD, from the application information; and
production of a markup language document, which is valid with respect to the DTD, from the information representation.

22. (Amended) The method as claimed in claim 21, wherein the application parameters are checked syntactically and/or semantically before the DTD-conformal information representation is produced from them.

23. (Amended) The method as claimed in claim 21, wherein the application parameters are checked to ensure that the sense of their content is correct before the DTD-conformal information representation is produced from them.

24. (Amended) The method as claimed in claim 21, wherein the process of producing the valid markup language document comprises the following steps:
production of calls from the DTD-conformal information representation, which are conforming with a predetermined API;
transmission of the API-conformal calls to a markup language processor via an interface which is conforming with this API;
execution of the API-conformal calls in order to process the valid markup language document.

25. (Amended) The method as claimed in claim 21, wherein the application information items are appliance configuration parameters for at least one configurable appliance.

26. (Amended) The method as claimed in claim 21, wherein the process of producing the API-conformal calls is carried out by means of a preprocessor as claimed in claim 1.

27. (Amended) A computer program product which can be loaded into an internal memory in a digital data processing means and which comprises computer program code means which execute the method as claimed in claim 21 when they are loaded and run in a data processing means.
